(19) United States
(12) Patent Application Publication
(10) Pub. No.: US 2012/0238120 A1
(43) Pub. Date: Sep. 20, 2012

(54) ALL-IN-ONE CONVERTER STRUCTURE

(76) Inventor: Po-Chin HUANG, (US)

(21) Appl. No.: 13/419,312

(22) Filed: Mar. 13, 2012

(30) Foreign Application Priority Data
Mar. 18, 2011 (TW) 100109255

(51) Int. Cl. H01R 25/00

(52) U.S. Cl. 439/284

(57) ABSTRACT

The present invention provides an all-in-one converter structure, which has a plurality of plugs each having a different type of connector. A user can choose an appropriate connector from the plurality of plugs. The plurality of plugs are connected with each other via at least a flexible connecting member. Thereby, no loss problem of plug will occur. In addition, the flexible connecting member are more damage-resistant than rigid connecting members.

### FIELD OF THE INVENTION

The present invention relates generally to a converter structure, and particularly to a converter structure having combinations of multiple types of connectors.

### BACKGROUND OF THE INVENTION

It is known according to prior art that a signal cable can be adopted to connect two electronic devices for transferring signals therebetween conveniently or charging one of the electronic devices. In general, the plugs at ends of the signal cable are put into the corresponding sockets in the two electronic devices. Thereby, the two electronic devices can transfer messages to each other or charge one of them via the electrical connection of the plugs and the sockets and via the signal cable. The plug of a normal signal cable has only one type of connector. If the type of the connector of the plug of the signal cable is different from that of the socket of the electronic device, the type of the connector of the plug cannot be replaced immediately. It is necessary to waste time for finding another signal cable.

With progresses in technologies, new types of connectors emerge continuously. The types of connectors of the plugs for various electronic devices are different. If a single signal cable is to be used for various electronic devices, it is indispensable to prepare the corresponding converters or other signal cables. Consequently, while using the plugs and the converters, it is unavoidable to have frequent plugging and unplugging, and hence leading to inconvenient operations and loss of converters.

According to Taiwan invention patent publication number I307193, a multi-functional and simple transfer plug, which comprises an insulation shell, a first signal plug, a second signal plug, and a connecting portion corresponding to the second signal plug. The insulation shell has two side arms and has a first pivotal portion. The first signal plug and the connecting portion corresponding to the second signal plug are assembled in the insulation shell face-to-face and connected electrically. The second signal plug is movably assembled with the insulation shell and can connect with the connecting portion corresponding to the second signal plug. The signal plug forms a sliding groove at its side edge for corresponding to the first pivotal portion. Nonetheless, according to its technological features, because the side arms are made of rigid materials, the moving range between the signal plugs is limited by the two sidewalls. In addition, the rigid side arms are prone to breakage.

Accordingly, the present invention provides an all-in-one converter structure, which uses flexible connecting members to connect various plugs. The all-in-one converter structure has a plurality of plugs connected by the flexible connecting members. Thereby, when the plurality of plugs are plugged and unplugged, no loss problem of the plugs will occur. Besides, the flexible connecting members can be flexed arbitrarily and are damage-resistant. They can be assembled with each other form an integral part, which is convenient for carrying.

### SUMMARY

An objective of the present invention is to provide an all-in-one converter structure, which provides a plurality of plugs each having a different type of connector. A user can choose an appropriate connector from the plurality of plugs.

Another objective of the present invention is to provide an all-in-one converter structure. A plurality of plugs provided by the present invention can be assembled with each other to form an integral part for convenient carrying. When the plurality of plugs are plugged and unplugged, they are connected via at least a flexible connecting member. Thereby no loss problem of plugs will occur. In addition, the flexible connecting member can be flexed arbitrarily and are damage-resistant.

For achieving the objective described above, the present invention provides an all-in-one converter structure, which comprises a first plug and a second plug. The first plug has a first electrical connector at one end. The second plug has a second electrical connector at one end and a second connecting part at the other end. A plurality of electrical connecting circuits are disposed inside the second plug for interconnecting the second electrical connector and the second connecting part. The first electrical connector plugs to the second connecting part. Moreover, the present invention further comprises a flexible connecting member with both ends disposed on the first and the second plugs, respectively.

The present invention provides another al-in-one converter structure, which comprises a transmission wire, a bidirectional reel, a first plug, and a second plug. The bidirectional reel is used for reeling the transmission wire. One end of the first plug is connected with the transmission wire; the other end thereof has a first electrical connector. A plurality of electrical connecting circuits are disposed inside the first plug for interconnecting the first electrical connector and the transmission wire. One end of the second plug has a connecting part corresponding to the first electrical connector; the other end thereof has a second electrical connector. A plurality of electrical connecting circuits are disposed inside the second plug for interconnecting the connecting part and the second electrical connector. Moreover, the present invention further comprises a flexible connecting member with both ends disposed on the first and the second plugs, respectively.

### BRIEF DESCRIPTION OF THE DRAWINGS

FIG. 1a and FIG. 1b show three-dimensional views of an all-in-one converter structure according a first embodiment of the present invention;

FIG. 2 shows an assembly view of an all-in-one converter structure according the first embodiment of the present invention;

FIG. 3 shows schematic diagrams of a flexible connecting member disposed in a positioning part according the first embodiment of the present invention;

FIG. 4a and FIG. 4b show three-dimensional views of an all-in-one converter structure according a second embodiment of the present invention;

FIG. 5 shows an assembly view of an all-in-one converter structure according the second embodiment of the present invention;

FIG. 6 shows a schematic diagram of the bottom of a first plug according the second embodiment of the present invention; and

FIG. 7 shows a schematic diagram of an inserting member assembled to the first plug according to the second embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention is an all-in-one converter structure, which provides a converter structure having multiple types of connectors so that a user can choose the plug satisfying his need from a plurality of plugs. In addition, the plurality of plugs plug with each other, and thus forming an integral body and interconnecting through at least a flexible connecting member. Accordingly, the all-in-one converter structure is convenient for carrying and no loss problem of the plugs will occur.

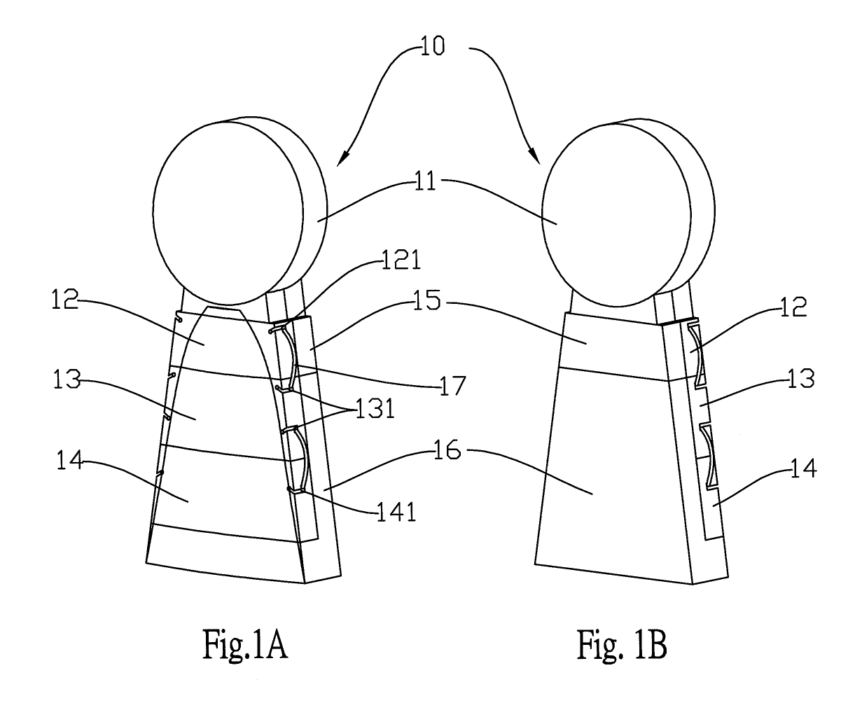

FIG. 1a and FIG. 1b show three-dimensional views of an all-in-one converter structure according a first embodiment of the present invention. The all-in-one converter structure 10 according to the present invention comprises at least a first plug 12 and a second plug 13. A first electrical connector 122 is disposed at one end of the first plug 12; a second electrical connector 132 at one end of the second plug 13 and a connecting part 133 is disposed at the other end thereof. The second electrical connector 132 is connected electrically with the connecting part 133 via a plurality of electrical connecting circuits (not shown in the figure). The first electrical connector 122 is plugged into the connecting part 133, and thereby the connecting part 133 of the second plug 13 is an electrical connector and corresponds to the first electrical connector 122. For example, the first electrical connector 122 is a male USB; the connecting part 133 of the second plug 13 is a female USB. The first plug 12 and the second plug 13 can be interconnected through at least a flexible connecting member 17. One end of the flexible connecting member 17 is disposed at the first plug 12 while the other end thereof is disposed at the second plug 13. The converter structure 10 according to the present embodiment further comprises a third plug 14 having a structure identical to the structure of the second plug 13. One end of the third plug 14 has a third electrical connector 142 while the other end thereof has a connecting part 153. The third electrical connector 142 is connected electrically with the connecting part 143. The connecting part 143 of the third plug 14 is a connector and corresponds to the second electrical connector 132. The second electrical connector 132 can be plugged to the connecting part 143 of the third plug 14. The second plug 13 and the third plug 14 can be interconnected via at least a flexible connecting member 17.

Besides, the second and the third plugs 13, 14 can be replaced by other plugs. For example, if the third plug 14 is to be replaced, a substitute plug having a connecting part and an electrical connector, just like the third plug 14, is provided. The electrical connector of the substitute plug is different from the third electrical connector 142 of the third plug 14. Nevertheless, once the connecting part of the substitute plug corresponds to the second electrical connector 132 of the second plug 13, the substitute plug can be assembled with the second plug 13. Thereby, the various plugs according to the present embodiment can be replaced by substitute plugs different from the electrical connectors of the current plugs.

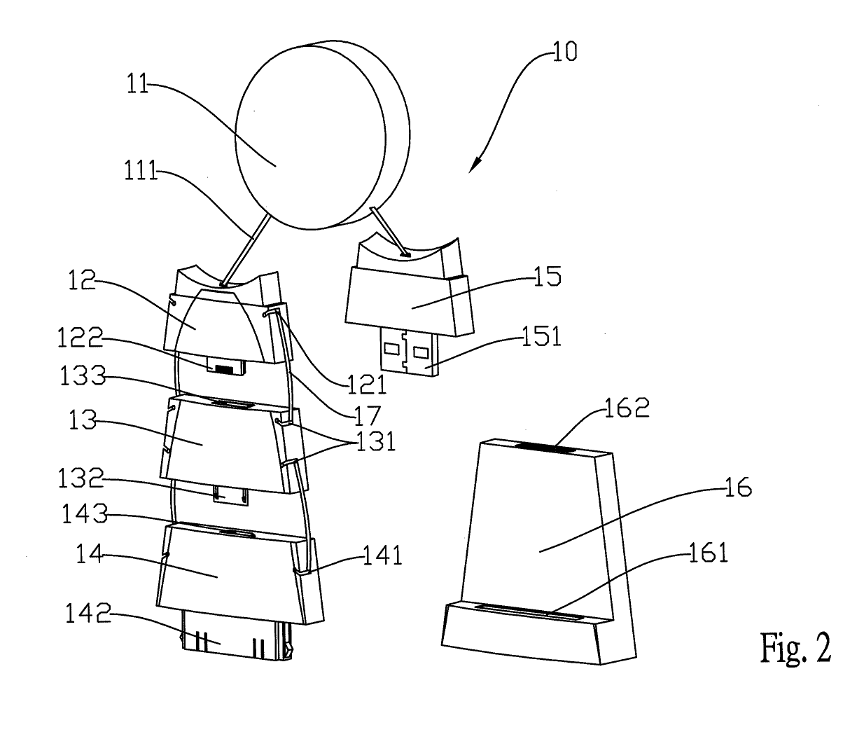

Referring again to FIG. 2, the first, the second, and the third plugs 12, 13, 14 according to the present embodiment can be connected via two flexible connecting members 17. The material of the flexible connecting member 17 includes rubber, nylon, or other extendable materials. The flexible member 17 is elastic, making it less prone to breakage than general rigid connecting members are. Both ends of the flexible connecting member 17 is disposed at positioning parts of two adjacent plugs. Taking the first and the second plugs 12, 13 for example, one side of the first plug 12 according to the present embodiment has a positioning part 121; one side of the second plug 13 has two positioning parts 131. One end of the flexible connecting member 17 is disposed in the positioning part 121 of the first plug 12 while the other end thereof is disposed in the positioning part 131 of the second plug 13.

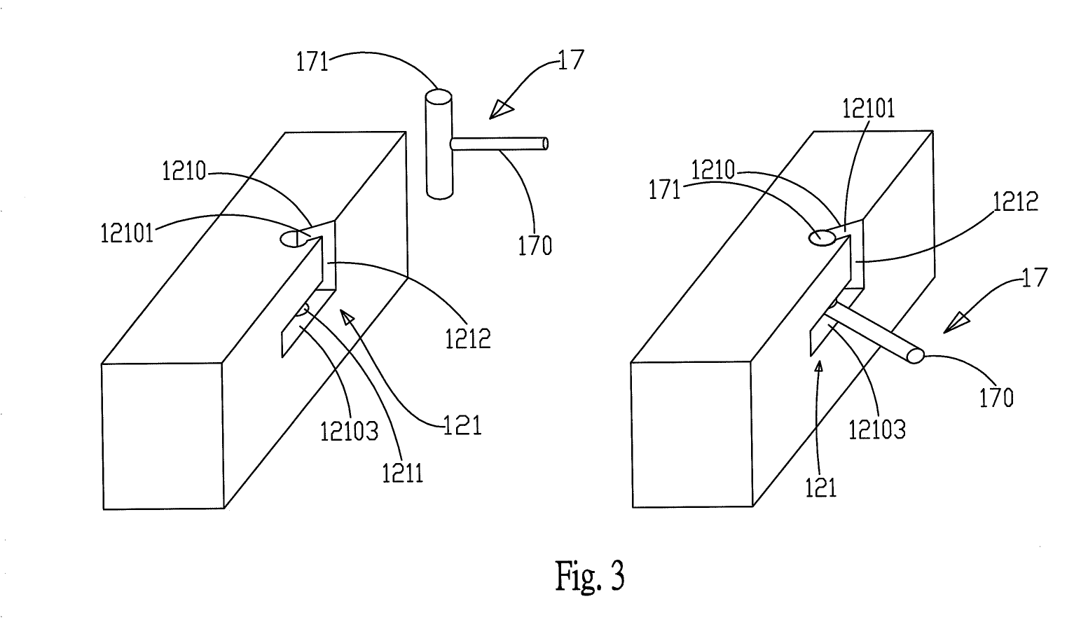

FIG. 3 shows schematic diagrams of the flexible connecting member disposed in the positioning part according the first embodiment of the present invention. The flexible connecting part 17 includes a connecting wire 170 and two positioning members 171. The two positioning members 171 are disposed at both ends of the connecting wire 170, respectively. The positioning part 121 located at the first plug 12 is a positioning groove 1210 with a hole 1211 at its bottom. According to the present embodiment, the outer side of the positioning groove 1210 is L-shaped. However, outer side of the positioning groove 1210 can also be T-shaped or any other shapes. Thereby, the connecting wire 170 of the positioning part 171 slides into the positioning groove 1210 for securing and moving. Because the outer side of the positioning groove 1210 according to the present embodiment is L-shaped, the positioning groove 1210 includes a first positioning groove 12101 and a second positioning grove 12103. The first positioning groove 12101 is perpendicular to the second positioning groove 12103. By viewing from top of the positioning groove 1210, the angle between the line connecting the hole 1211 and an opening 1212 of the positioning groove 1210 and the edge of the first plug 12 is less than 90 degrees. The positioning part 121 according to the present embodiment is mainly used for positioning the flexible connecting member 17 and preventing the flexible connecting member from escaping the positioning part 121. According to the present embodiment, disposing the flexible connecting member 17 in the positioning part 121 of the first plug 12 is taken as an example. The structures of the positioning parts of the other plugs are identical to the structure of the positioning part 12 of the first plug 12, and hence will be described further.

For assembling the flexible connecting member 17 to the positioning part 121, first the positioning member 171 of the flexible connecting member 17 enters the first positioning groove 12101 of the positioning groove 1210 from the opening 1212 of the positioning part 121 and inserts into the hole 1211 inside the positioning groove 1210. Then the connecting wire 170 of the flexible connecting member 17 can move in the second positioning groove 12103 of the positioning groove 1210. Referring back to FIG. 2, when the first plug 12 plugs to the second plug 13, the connecting wire 170 of the flexible connecting member 17 bends and is almost perpendicular to the edge of the first plug 12. The connecting wire 170 is blocked by the sidewall above the second positioning groove 12103, making the positioning member 171 of the flexible connecting member 17 escape from the hole 1211. When the first plug 12 is disassembled form the second plug 13, the connecting wire 170 of the flexible connecting member 17 is linear owing to the separation of the first and the second plugs 12, 13 and moves in the second positioning groove 12103.

Refer again to FIG. 1 and FIG. 2. According to the present embodiment, the present invention further comprises a fourth plug 15. One end of the fourth plug 15 has a fourth electrical connector 151; the other end thereof connects to a transmission wire 111, which is connected electrically with the fourth electrical connector 151. The other end of the transmission wire 11 is connected electrically to the first electrical connector 122 of the firth plug 12 for transmitting signals through the transmission wire 111. The length of the transmission wire 11 might be too long. Thereby, the present embodiment further comprises a reel 11 for reeling the transmission wire 11 and controlling its length. The reel 11 can be unidirectional or bidirectional. According to the present embodiment, the reel 11 is bidirectional. The first and the fourth plugs 12, 15 connecting with the transmission wire 11 according to the present embodiment are one the same side of the reel 11. Thereby, the first and the fourth plugs 12, 15 drive both ends of the transmission wire 11 to extend or retract in the same direction. The extension and retraction direction of the transmission wire 111 described above is a preferred embodiment. Alternatively, the first and the fourth plugs 12, 15 can be located on both sides of the reel 11 for driving the transmission wire 111 to extend or retract in two different directions. The reel 11 described above is bidirectional. The first and the fourth plugs 12, 15 drive the transmission wire 111 to extend or retract in the same direction. Of course, the first and the fourth plugs 12, 15 can also drive both ends of the transmission wire 111 to extend or retract in opposite or other directions. For implementation, only the structure for guiding the transmission wire 111 in the reel 11 is to be modified. The details will not be described further.

For using the converter structure 10, the fourth electrical connector 151 of the fourth plug 15 is first connected electrically with an electronic device (such as a desktop PC or a notebook computer). The user chooses an appropriate plug from the first, the second, and the third plugs 12, 13, 14 according to another electronic device (such as a PDA or a smart phone) to be connected to. If the first plug 12 is chosen, the second plug 13 is disassembled from the first plug 12 and the first plug 12 is plugged to another electronic device. The disassembled second plug 13 and the third plug 14 are connected with the first plug 12 via the flexible connecting member 17. Hence, loss of the second and the third plugs 13, 14 will not happen.

Refer again to FIGS. 1 and 2. The converter structure 10 further comprises a protection lid 16 having a first holding trench 161 and a second holding trench 162. When the protection lid 16 is assembled with the third and the fourth plugs 14, 15, the third electrical connector 142 of the third plug 14 is plugged into the first holding trench 161, and the fourth electrical connector 151 of the fourth plug 15 is plugged into the second holding trench 162. Thereby, the third electrical connector 142 of the third plug 14 and the fourth electrical connector 151 of the fourth plug 15 are protected, and hence avoiding damages caused by external dusts and moisture entering the third electrical connector 142 as well as the fourth electrical connector 151.

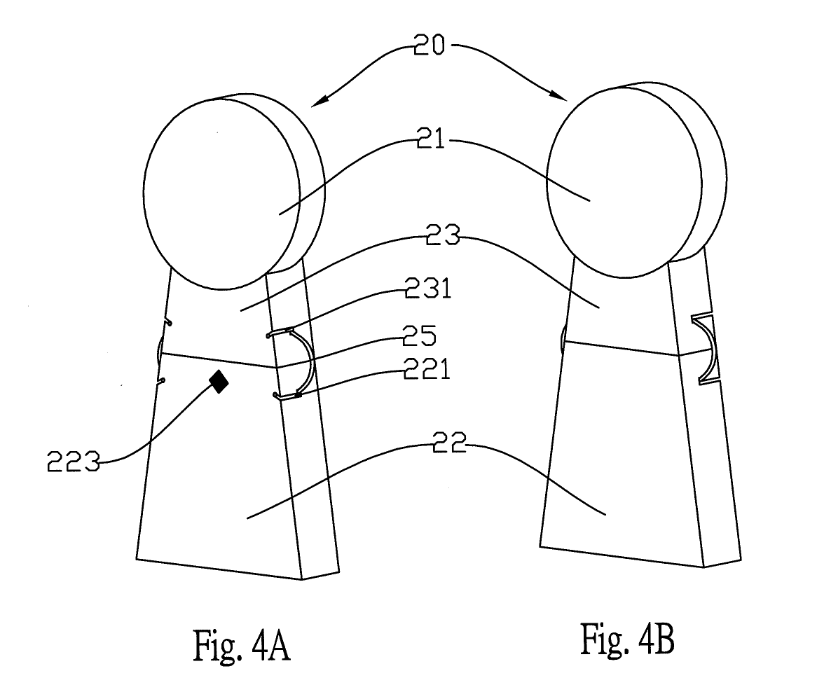

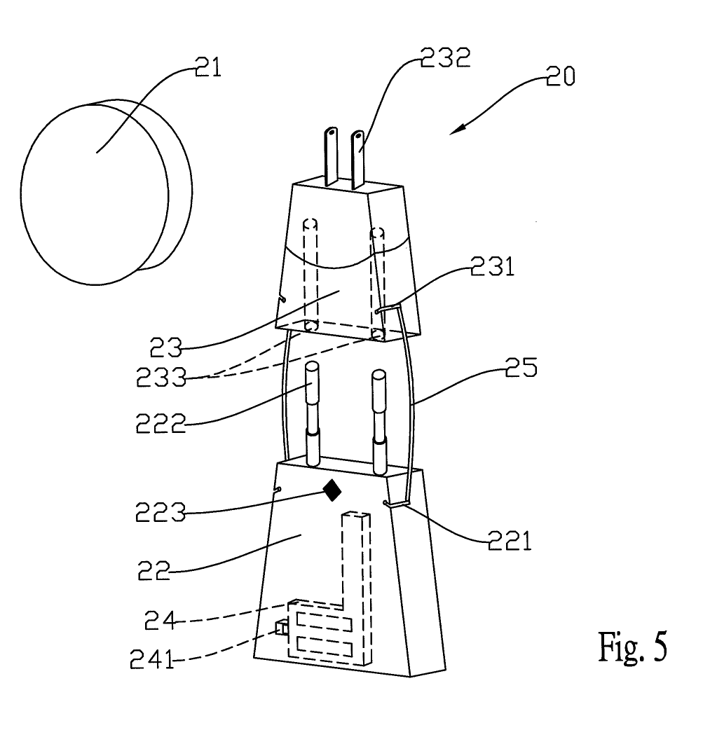

FIGS. 4a, 4b, and 5 show three-dimensional views and an assembly view of an all-in-one converter structure according a second embodiment of the present invention. The difference between the present embodiment and the one described above is that according to the first embodiment, the first, the second, and the third electrical connectors 122, 132, 142 are USB or Mini USB. According to the present embodiment, the first electrical connector 222 and the second electrical connector 232 are plugs with different specifications. Thereby, the connecting part 233 of the second plug 23 corresponds to the socket of the first electrical connector 222.

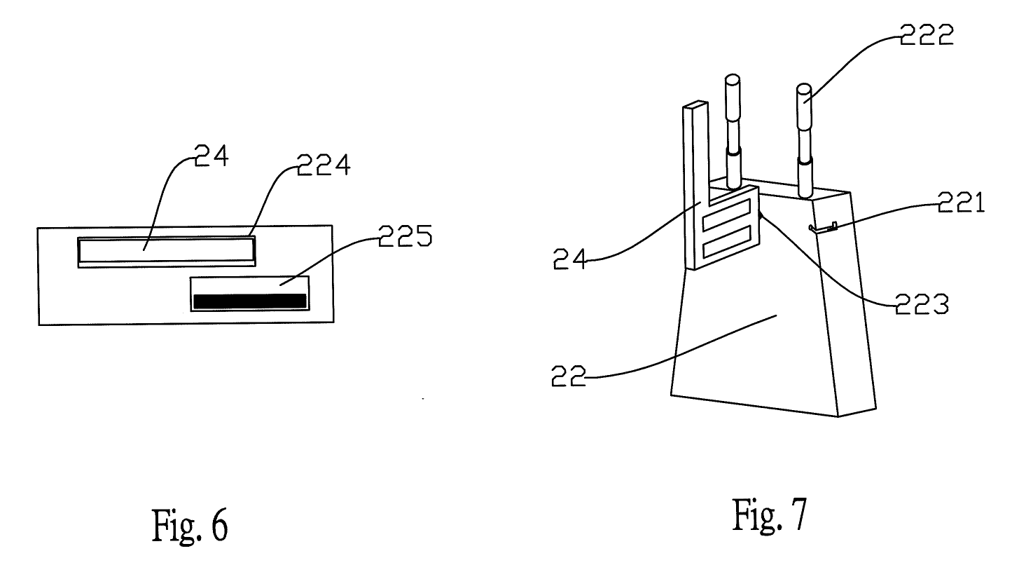

FIG. 6 and FIG. 7 show schematic diagrams of the bottom of the first plug and of an inserting member assembled to the first plug according the second embodiment of the present invention. According to the present embodiment, the converter structure 20 further comprises an inserting member 24. While traveling abroad, because some countries use three-lead sockets, the inserting member 24 has to be disposed to the first plug 22 for forming a plug with three leads. The first plug 22 has a fixing part 223; the inserting member 24 has a tenon 241 inserting into the fixing part 223 for fixing the inserting member 24. The bottom of the first plug 22 according to the present embodiment further includes a holding trench for inserting member 224, which is used for holding the inserting member 24 and thus enhancing user carrying. In addition, the bottom of the first plug 22 according to the present embodiment further includes a connecting part 225, which is an electrical connector. Thereby, the user can connect electrically the connecting part 225 with an electronic device via another transmission wire and hence charging the electrical device.

To sum up, the present invention provides an all-in-one converter structure, which features that the converter structure has a plurality of plugs. The plurality of plugs have electrical connectors of various types. By carrying multiple plugs at the same time, a user can choose the appropriate plug according to his demand. The plurality of plugs are connected to form an integral body for easy carrying. Besides, at least a flexible connecting member is used for connecting the plugs. Thereby, even if the plugs are separated, they are still connected via through the flexible connecting members, preventing the plugs from loss. The material of the flexible connecting members includes rubber or nylon having elastic properties. Hence, in comparison with general rigid connecting members, they are less prone to breakage. Moreover, unlike rigid connecting members, the moving space of the plugs will thereby not be limited.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An all-in-one converter structure, comprising:
a first plug, having a first electrical connector at one end; and
a second plug, having a second electrical connector at one end and a second connecting part at the other end, having a plurality of electrical circuits therein for interconnecting said second electrical connector and said second connecting part, and said first electrical connector plugging into said second connecting part;
where said all-in-one converter structure further comprises a flexible connecting member with both ends disposed at said first plug and said second plug, respectively.

2. The all-in-one converter structure of claim 1, wherein said first plug further includes a connecting part and a plurality of electrical circuits therein for interconnecting said first electrical connector and said connecting part; said first plug and said second plug have at least a positioning part, respectively; and both ends of said flexible connecting member are positioned in said positioning parts, respectively.

3. The all-in-one converter structure of claim 1, and further comprising an inserting member, inserting into said first plug or said second plug, having a tenon, said first plug or said second plug having a fixing part, said tenon inserting into said fixing part, and said fixing part fixing said inserting member in said first plug or said second plug, wherein said first plug further includes a holding trench for inserting member for holding said inserting member.

4. The all-in-one converter structure of claim 1, and further comprising a protection lid, covering said first electrical connector of said first plug, and having at least a holding trench for disposing said first electrical connector.

5. The all-in-one converter structure of claim 1, wherein the material of said flexible connecting member includes rubber, nylon, or extendable materials.

6. An all-in-one converter structure, comprising:
a transmission wire;
a reel, used for reeling said transmission wire;
a first plug, connecting to said transmission wire at one end, having a first electrical connector at the other end, having a plurality of electrical circuits therein for interconnecting said first electrical connector and said transmission wire; and
a second plug, having a connecting part corresponding to said first electrical connecting part at one end, having a second electrical connector at the other end, and having a plurality of electrical circuits therein for interconnecting said connecting part and said second electrical connector;
where said all-in-one converter structure further comprises at least a flexible connecting member with both ends disposed at said first plug and said second plug, respectively.

7. The all-in-one converter structure of claim 6, wherein one end of said transmission wire has a plug having an electrical connector.

8. The all-in-one converter structure of claim 6, and further comprising a plurality of positioning parts disposed in said first plug and said second plug, respectively;
both ends of said flexible connecting member positioned at said plurality of positioning parts, respectively; and the material of said flexible connecting member including rubber, nylon, or extendable materials.

9. The all-in-one converter structure of claim 6, and further comprising an inserting member, inserting into said first plug or said second plug, having a tenon, said first plug or said second plug having a fixing part, said tenon inserting into said fixing part, and said fixing part fixing said inserting member in said first plug or said second plug, wherein said first plug further includes a holding trench for inserting member for holding said inserting member.

10. The all-in-one converter structure of claim 6, and further comprising a protection lid, covering said first electrical connector of said first plug, and having at least a holding trench for disposing said first electrical connector.
